(19) United States
(12) Patent Application Publication
(10) Pub. No.: US 2026/0302705 A1
(43) Pub. Date: Oct. 1, 2026

(54) Electrical and Electronic Connector Cleaning Tool

(71) Applicant: Garrin R. Walker, Garland, TX (US)

(72) Inventor: Garrin R. Walker, Garland, TX (US)

(21) Appl. No.: 19/095,525

(22) Filed: Mar. 31, 2025

(51) Int. Cl. H01R 43/00

(52) U.S. Cl. CPC H01R 43/002

(57) ABSTRACT

A cleaning tool for a multi-conductor connector has a tool body, two or more cleaning devices such as brushes at a distal end of body, wherein the cleaning devices are held in an electrical and mechanical pattern (arrangement) to match and mate with the multi-conductor connector, an actuator, and a transmission mechanism between the actuator and the two or more cleaning devices such that operation of the actuator is conveyed via the transmission mechanism to the two or more brushes to operate the brushes in a cleaning motion.

### FIELD OF THE INVENTION

The present invention relates to tools for cleaning electrical and electronic connectors such as, but not limited to, multi-pin or multi-socket audio connectors, computer connectors, medical equipment connectors, military systems connectors, automation and robotics connectors, etc.

### BACKGROUND OF THE INVENTION

Electrical connectors are used throughout common equipment, especially multi-pin or multi-signal connectors. These connectors take many sizes and shapes, depending on the nature of the signals they conduct, such as low voltage signals (e.g., 3V, 5V, 12V, etc.) or high-current, high-voltage (e.g., 120V, 220V, etc.). The shape often includes a physical “key” mechanism of some sort to ensure that the signals are properly interconnected in a safe and functional manner, including, in some models, a provision that certain connections are made first (connected first during the process of being plugged in, etc,) as the connectors are joined and/or disconnected last as the connections are being broken (disconnected last during the process of unplugging) such as a ground or common signal connection, pin, etc.

For example, as shown in FIG. 2, a very common connector for a microphone signal from the audio electronics technologies is shown. On the left is shown a “female” XLR3 connector 200, and on the right is a corresponding, mating “male” XLR3 connector 201, as photographs show on Wikipedia (no copyright claimed). According to Wikipedia, “[t]he generic term “XLR” began as a trademark of Cannon Electric, with the letters standing for X model connector with an added “L”atch feature, and “R”esilient neoprene rubber surrounding the female contacts”. Commonly, a number representing the number of signals or connections is appended to XLR, such as XLR3 being a 3 signal connector, and XLR 6 being a 6 signal connector as shown 300 in FIG. 3. Also, sometimes, but no always, connectors are characterized by “male” and “female”, wherein male connectors typically have multiple electrically-exposed (uninsulated) pins, and female connectors typically have multiple recesses or sockets for receiving the pins of the male connectors. And, some connectors are designed to be attached to an end of a cable, such as a bundled wire cable, while others are “panel mount” designs for attaching to a rigid structure such as a panel or chassis frame. For example, FIG. 2 shows two cable-end XLR3 connectors, a female on the left 200 and a male on the right 201, while FIG. 3 shows 300 a panel mount XLR6 connector.

Similarly, other common signal interconnects are provided in similar mechanical and electrical predetermined arrangements, such as a 13-pin European female 400 and male 401 car-to-trailer connector (as shown by on https://www.Highlight-LED.de by World Trading Net GmbH & Co. KG of Germany, EU) or the very common 4-pin North American trailer “flat” connector 500 in FIG. 5 (as shown online by TrailerParts.com of New Jersey, USA). The flat connector example shows two interesting points of variation: (a) it is in a linear arrangement instead of a generally “round” shape as many others, and (b) each connector has a combination of female sockets and male pins making it purely a conventional designation as to which of the A or B connectors is “male” or “female” (usually determined by whether the connector has more of one type of connections than the other type, but not always).

Many other multi-signal and multi-conductor connectors are well-known in the arts which follow these general patterns of electrical and mechanical arrangements, including but not limited to connectors used in military, industrial, medical, video, audio, computer, telecommunications, power, vehicles, and robotics.

All of these types of connectors may become “dirty” during plugging-in operations, which can force debris, lint, and other contaminants into the female sockets which then becomes trapped. For example, female microphone connectors which are often mounted in the floor of a stage facing upwards are well known to collect dust and dirt, and sometimes even liquids (spilled beverages, mopping solutions, rain, etc.).

Additionally, each of these connectors'conductive surfaces, such as copper, tin or gold plating, may be subject to corrosion and oxidation, especially if used in certain environments such as near water, humidity, detergents, etc.

The combination of trapped debris and corrosion in the female receptacles of electronic and electrical connectors reduces the signal quality conducted through the connector and may lead to intermittent connections or even failure of the connector.

### SUMMARY OF THE INVENTION

A cleaning tool for a multi-conductor connector is disclosed having a tool body, two or more cleaning devices such as brushes at a distal end of body, wherein the cleaning devices are held in an electrical and mechanical pattern (arrangement) to match and mate with the multi-conductor connector, an actuator, and a transmission mechanism between the actuator and the two or more cleaning devices such that operation of the actuator is conveyed via the transmission mechanism to the two or more brushes to operate the brushes in a cleaning motion.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 illustrates an example embodiment according to the present invention.

FIG. 2 provides an example of well-known XLR3 cable-end matching (mating) connectors.

FIG. 3 shows an example of a well-known panel-mount female XLR3 connector.

FIG. 4 provides an example of well-known European car-trailer matching (mating) connectors.

FIG. 5 illustrates an example of well-known North American car-trailer matching (mating) connectors.

FIG. 6 provides more details of internal components of the example embodiment of FIG. 1.

FIG. 7 provides more details of a transmission of the example embodiment of FIG. 6.

FIG. 8 provides more details of a brush configuration of the example embodiment of FIG. 1.

### DETAILED DESCRIPTION

The present inventor(s) have improved upon the known structures, mechanisms and design of devices to clean and restore female receptacles of electronic and electrical connectors, and especially for multi-signal, multi-pin connections. Certain tools are well known in the art for cleaning female receptacles of electronic and electrical connectors, including brushes, solvents, vacuums and cans of compressed air.

Electrical solvents, such as DeoxIT D5 Contact Cleaner 5% Solution [TM] available from CAIG Laboratories Inc. of California, USA, use a chemical approach to clean female receptacles of electronic and electrical connectors. Such solvents may remove or reduce oxidation, but may fail to remove debris, thereby only providing a partial solution to the problem. Further, when used to clean a lot of connectors at once, especially in poorly ventilated areas, cleaning solvents may pose a hazard to the user due to the fumes from the chemicals.

Specialized vacuums designed for cleaning electronic products such as computer motherboards may be of some, albeit limited, effectiveness in removing debris from female receptacles of electronic and electrical connectors. Some female connectors provide very small apertures through which the vacuum may pull debris, such as low voltage and computer signal connectors, and may therefore be only partially effective at cleaning such connectors.

Specialized cans of compressed air with small applicant straws designed for cleaning electronic products such as computer keyboards may also be of some, albeit limited, effectiveness in removing debris from female receptacles of electronic and electrical connectors. As previously considered, some female connectors provide very small apertures through which the compressed air may blast away debris, such as low voltage and computer signal connectors, and may therefore be only partially effective at cleaning such connectors.

Known brushes tend to be of a single brush type, often taking the form of a long, twisted core with bristles captured in the twists and extending radially from the core. Such brushes, however, require the user to clean each female receptacles of an electronic or electrical connector individually, one at a time, which is time consuming, tedious, and may lead to missed receptacles. Solvent products may also be labeled with warnings regarding use on certain materials and surfaces, such as touch screens.

Because of each cleaning method's limitations and shortcomings, it is not uncommon for users to apply multiple techniques in an attempt to clean female receptacles of electronic and electrical connectors. For this reason, it is possible to find “kits” and “tool sets” of connector cleaning brushes, solvents, and driven-air products provided by retailers for each market segment.

The present inventor has realized that there remains an unsatisfied need and unsolved problems in the art of cleaning female receptacles of electronic and electrical connectors, especially multi-signal or multi-conductor electronic and electrical connectors. The objectives of this invention will be apparent from the following paragraphs and exemplary embodiments.

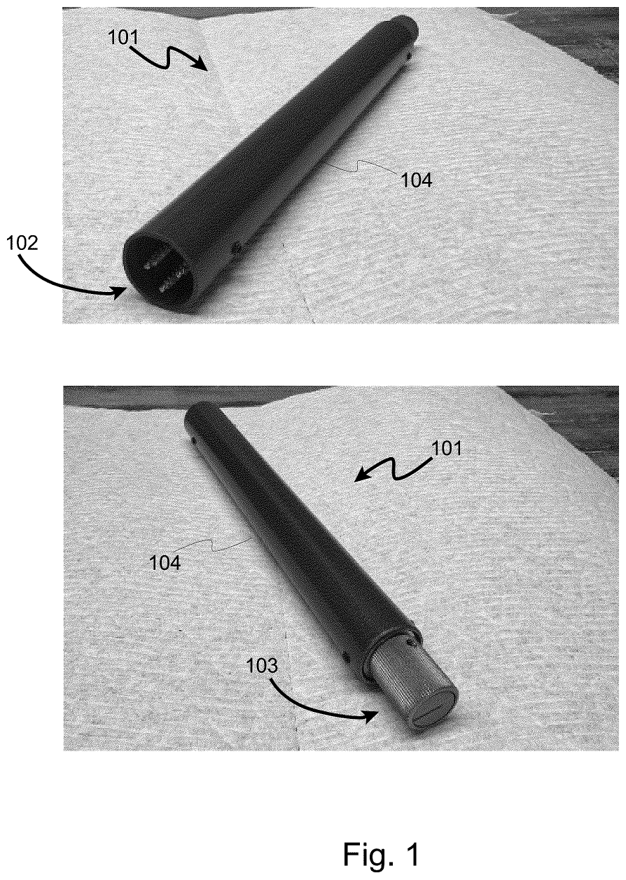

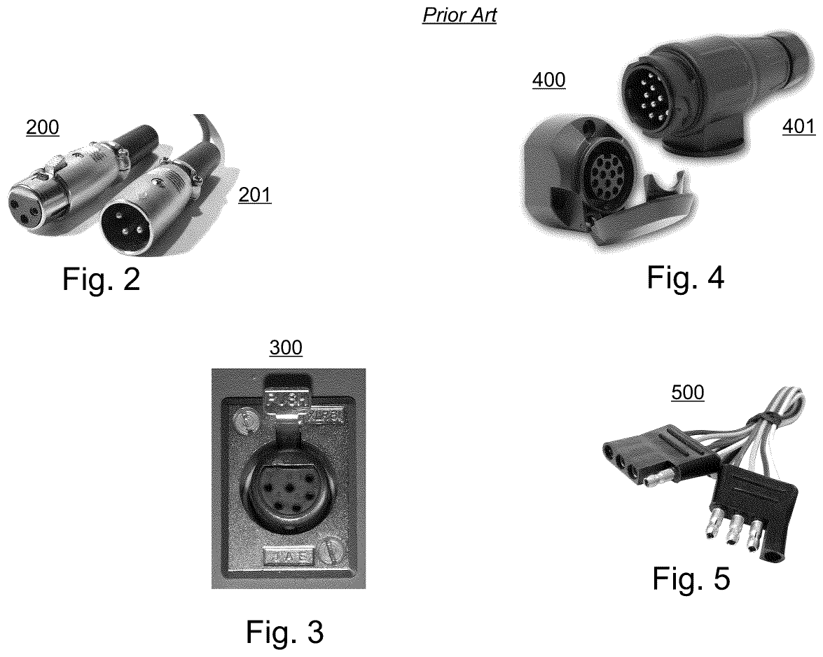

Female XLR3 Cleaning Tool. Turning now to FIG. 1, photographs are shown 100 of a prototype 101 of at least one embodiment according to the present invention. It has a distal end 102 for connection to a female XLR3 connector, and a proximal end 103 for actuating the motion of the brushes to clean female receptacles of electronic and electrical connectors, and a body portion 104 extending between the proximal and distal ends. This example embodiment allows for cleaning all three female receptacles simultaneously, greatly reducing the time required to clean multiple connectors, such as a large patch panel with dozens of XLR3's, and increases the likelihood of all the receptacles getting cleaned and none being missed.

To operate this particular embodiment, the user simply holds the tool 101 by the body 104 in a first hand, inserts the brushes of the distal end 102 into an XLR connector, and uses a second hand to rotate the knob on the proximal end 103. Rotation of the knob causes the brushes received into the receptacles to rotate, thereby cleaning all receptacles at the same time with just a few twists. Then, the user simply withdraws the tool from the XLR connector, and moves to the next XLR connector for cleaning, quickly and conveniently.

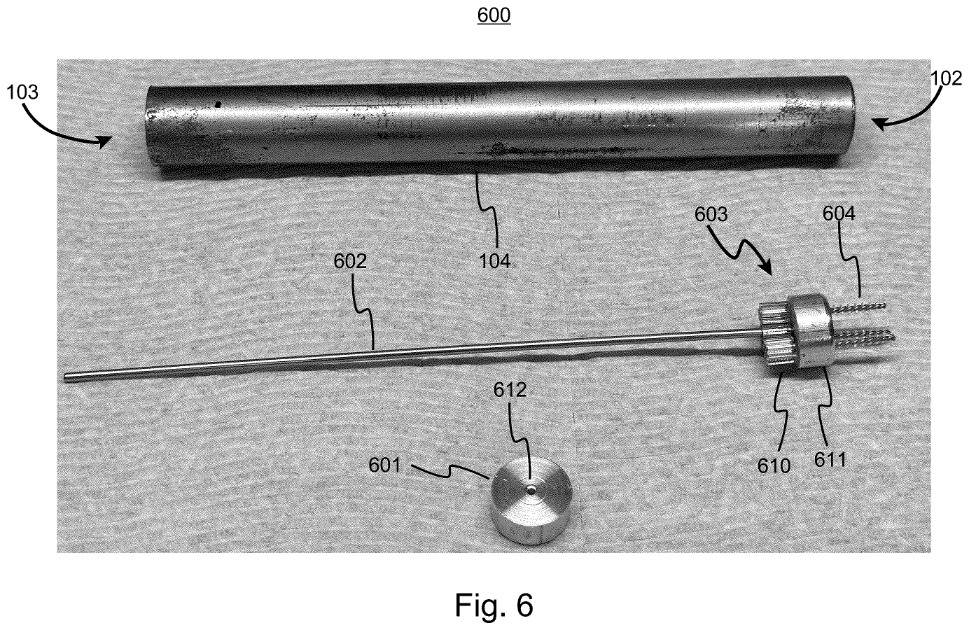

Referring now to FIG. 6, details of the mechanisms are shown 600 of this particular embodiment. The body 104, which serves as a user handle, is essentially a hollow tube or cylinder into which a drive shaft 602, proximal guide 601 and distal transmission 603 are received. In this example, the length of the drive shaft 602 is sufficiently long as to extend from a distal guide 611, through the body 104 and through the proximal guide, and to provide a portion beyond an aperture 612 in the proximal guide 601 sufficient to receive an actuating knob (not shown in this diagram), such as a traditional volume adjustment knob. The distal guide and the proximal guides maintain the drive shaft essentially parallel to the longitude of the body, and allow the drive shaft to rotate as the actuating knob is rotated. A set of gears 610 rotationally connect the drive shaft to the individual brushes 604.

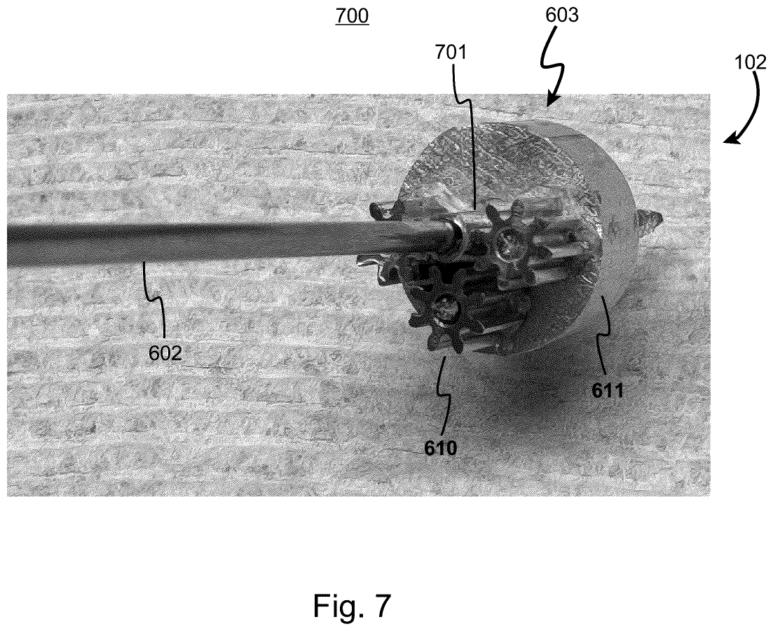

Turning to FIG. 7, details of an exemplary transmission 603 are shown 700 for this particular, exemplary embodiment. The distal end of the drive shaft 602 is received into the distal guide 611, and is provided with a central gear 701. The shank ends of each brush is received into the distal guide, each of which are provided gears 610 which which meshed to the central gear such that rotation of the drive shaft causes rotation of the brushes. The other end (proximal end) of the drive shaft is received into and through the proximal guide.

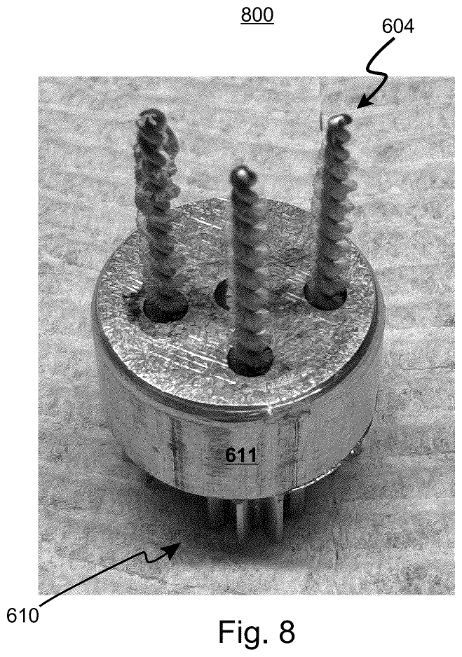

As shown 800 in FIG. 8, the formation or configuration of the brushes 604 is determined and controlled by the distal guide 611, which is designed to match the configuration and spacing of female receptacles for the connector to be serviced. This particular example embodiment utilizes wire bristle twisted core brushes.

In this manner, the multi-brush cleaning tool matches and corresponds to the pattern of receptacles in a certain connector, such as an XLR3 connector in this example embodiment.

Other Embodiments. As those ordinarily skilled in the art will recognize, the foregoing example embodiment is but one possible embodiment within the spirit and scope of the present invention. Other embodiments include but are not limited to:
a. embodiments which include more or fewer brushes to clean connectors with more or fewer female receptacles;
b. embodiments which include one or more rotating male pin cleaners to clean connectors with male pins;
c. embodiments which match other pin and socket configurations of multi-signal and multi-conductor connectors which employ patterns of electrical and mechanical arrangements, including, but not limited to connectors used in trailers, transportation, military, industrial, medical, video, audio, computer, telecommunications, printed circuit boards, removeable electronic components such as vacuum tubes, power interconnections, vehicles, and robotics.
d. embodiments which do not rotate the brushes but which allow for cleaning female receptacles by insertion and removal of the brushes;
e. embodiments which include other forms of transmission between the drive shaft and the brushes such as friction wheels, belts, etc.;
f. embodiments which allow the body to act as the drive shaft, thereby eliminating the internal drive shaft, allowing the user to hold the proximal end static while rotating the body;
g. embodiments which utilize an electric motor for the source of rotational energy applied to the brushes;
h. embodiments which include a source of illumination at the distal end to assist in alignment of the tool with a connector in dark environments;
i. embodiments which attach to a source of forced air, such as vacuum or compressed air, to enhance cleaning and debris removal;
j. embodiments which include a right angle differential for cleaning connectors where there is limited clearance for a tool;
k. embodiments which include a flexible drive portion for cleaning connectors where there is limited clearance for a tool; and
l. embodiments which attach to or provide a conduit for application of a solvent or other cleaning agent to the brushes or into the female receptacles.

Conclusion. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A cleaning tool for a multi-conductor connector, wherein the multi-conductor connector employs a first pattern of arrangement of electrical and mechanical elements including one or more of physical male pin spacing, physical female socket spacing, and a combination of male pin and female socket spacing, the cleaning tool comprising:
a tool body having a proximal end and a distal end;
two or more cleaning devices disposed near or at the distal end of the tool body, the two or more cleaning devices being held in a second pattern of electrical and mechanical arrangement of physical male pin spacing, or physical female socket spacing, or a combination thereof, wherein the second pattern is a mating match to the first pattern;
an actuator disposed away from the proximal end of the tool body, and being provide with a transmission mechanism between the actuator and the two or more cleaning devices such that operation of the actuator is conveyed via the transmission mechanism to the two or more brushes to operate the brushes in a cleaning motion.

2. The cleaning tool as set forth in claim 1 wherein the tool body comprises an essentially cylindrical tube, wherein the transmission mechanism comprises a drive shaft within the tube, and wherein the actuator comprises a rotatable knob.

3. The cleaning tool as set forth in claim 1 wherein the transmission mechanism comprises two or more mating gears.

4. The cleaning tool as set forth in claim 1 wherein the transmission mechanism comprises at least one roller.

5. The cleaning tool as set forth in claim 1 wherein the transmission mechanism comprises at least one wheel.

6. The cleaning tool as set forth in claim 1 wherein the transmission mechanism comprises at least one pulley.

7. The cleaning tool of claim 1 wherein the actuator comprises an electric motor.

8. The cleaning tool of claim 1 wherein the two or more cleaning devices comprise at least one brush having dimensions compatible with being received into a female socket of a multi-conductor connector.

9. The cleaning tool of claim 1 wherein the two or more cleaning devices comprise at least one brush having dimensions compatible with receiving a male pin of a multi-conductor connector.

10. The cleaning tool of claim 1 wherein the second pattern comprises a pattern suitable to mate with a first pattern of an audio connector.

11. The cleaning tool of claim 10 wherein the audio connector comprises an XLR connector.

12. The cleaning tool of claim 1 wherein the second pattern comprises a pattern suitable to mate with a first pattern of an electronics connector.

13. The cleaning tool of claim 12 wherein the electronics connector comprises a socket for an electronic vacuum tube.

14. The cleaning tool of claim 1 wherein the second pattern comprises a pattern suitable to mate with a first pattern a transportation system connector.

15. The cleaning tool of claim 14 wherein the transportation system connector comprises a trailer-to-tow vehicle connector.

16. The cleaning tool of claim 1 wherein the second pattern comprises a pattern suitable to mate with a first pattern selected from the group consisting of a video equipment connector, a military equipment connector, an industrial equipment connector, a medical equipment connector, a computer connector, a telecommunications connector, a power connector, a vehicle connector, and a robotic equipment connector.
